(19) United States
(12) Patent Application Publication
(10) Pub. No.: US 2012/0159295 A1
(43) Pub. Date: Jun. 21, 2012

(54) METHOD FOR SINGLE PAGE BROWSER MULTI-TASKING

(76) Inventor: Wayne S. Rabstejnek, Alpharetta, GA (US)

(21) Appl. No.: 13/329,045

(22) Filed: Dec. 16, 2011

Related U.S. Application Data
(60) Provisional application No. 61/423,653, filed on Dec. 16, 2010.

(51) Int. Cl. G06F 17/00

(52) U.S. Cl. 715/205; 715/234

(57) ABSTRACT

A web page provides multiple section containers, each having independently operating close control and history, without affecting the remainder of the web page. A menu on the page may permit the creation of the containers. An optional mode may be provided in which links within containers do or do not generate new containers within the web page.

This application claims priority to U.S. Provisional Application Ser. No. 61/423,653, filed Dec. 16, 2010.

### BACKGROUND

In order to provide business functionality to mobile devices, it becomes necessary to provide the ability to execute multiple independent functions on the same browser page, much like a computer running the Windows operating system.

In order to allow multiple independent processes to execute on the same web page, the HTML language supports the IFRAME tag. This tag allows an independent web page to operate independently within the <IFRAME></IFRAME> HTML tag.

As all browsers are not consistent in the way in which they execute, or even support HTML language elements, this tag alone does not support:
Forward and or backward navigation of browser history within the IFRAME (current Apple products do not provide for browser history within an (FRAME);
The ability to dynamically open new, independent IFRAME business process functions;
The ability to dynamically close or move independent IFRAME business process functions;
The ability to allow the user to dynamically control if linked content within an IFRAME is to open within the same IFRAME, or open in a completely new IFRAME on the same page.

Further, a single page of HTML may support independent processes executing within one or more IFRAME elements. However, the manipulation of these frames, including their closure, movement, or even creating a new IFRAME, typically requires the reload of the host HTML page. When that occurs, the independent processes in each of the IFRAMES are re-initialized to their initial state (or page), regardless of the progress or navigation made within each one.

### SUMMARY

The system and method described below accomplish all of the above mentioned shortcomings of the IFRAME in a manner that does not cause the original HTML page to be reloaded. The web page provides multiple section containers, each having independently operating close control and history, without affecting the remainder of the web page.

Although the IFRAME is leveraged as part of the solution, it is used only in its current capacity to provide independent HTML request/response processing.

A web page provides multiple section containers, each having independently operating close control and history, without affecting the remainder of the web page. A menu on the page may permit the creation of the containers. An optional mode may be provided in which links within containers do or do not generate new containers within the web page.

### BRIEF DESCRIPTION OF FIGURES

FIG. 1 is a schematic of one example system in which a web page is displayed.

FIG. 2 illustrates the components of the Single Page Browser Multi-Tasking Method.

FIG. 3 illustrates the method used to create a new independent process from a menu selection.

FIG. 4 illustrates the supporting server process interaction to support the creation of a new independent process.

FIG. 5 illustrates the process of setting analyze mode and the processing required to support it.

FIG. 6 illustrates the process of closing a server process.

FIG. 7 illustrates the process of moving a server process to another location on the web page.

FIG. 8 illustrates the process required to support independent forward and backward browser history within the server process.

FIG. 9 shows an example initial screen of the web page on a user's device.

FIG. 10 shows the screen of FIG. 9 with one section definition container.

FIG. 11 shows the screen of FIG. 10 with a second section definition container.

FIG. 12 shows the screen of FIG. 11 with the main menu closed.

FIG. 13 shows the screen of FIG. 12 with the second section definition container closed and a popup menu opened.

### DETAILED DESCRIPTION OF A PREFERRED EMBODIMENT

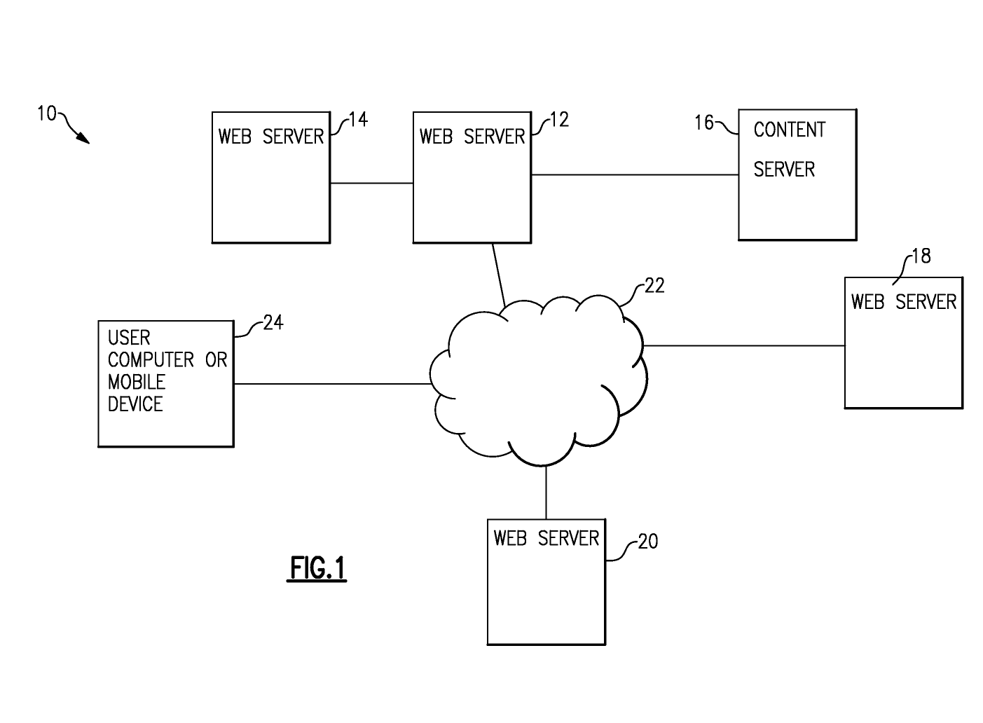

A system and method for displaying web pages is shown in the Figures. Referring to FIG. 1, a system 10 includes a web server 12, which may be connected to a second web server 14 and/or a content server 16. The web server 12 may also be connected to a plurality of remote web servers 18, 20 via a wide area network, such as the internet. The servers 12, 14, 16, 18, 20 are each a computer or cluster of computers, each including at least one processor and memory and/or other storage such as hard drives, etc, capable of storing programs which when executed by the processor perform the functions described herein. The servers could include virtual servers, but are ultimately running on hardware processors, memory, storage, etc.

A user computing device 24 is a computer (such as a desktop, laptop, tablet, etc) or mobile device (smartphone, iPhone, iPad, etc) capable of running a web browser application connected to the web server 12 via the WAN 22. The user computing device 24 includes at least one processor and memory and/or other storage such as hard drives, etc, capable of storing programs, including a web browser, which when executed by the processor perform the functions described herein.

Terminology

For the purposes of consistency, each independent function that can appear on the single HTML page is termed the “multi-tasking function.”

“Analyze Mode” defines the user control to specify whether or not an independent process continues to function within the same container (105), or spans a new container (105).

Basic Processing

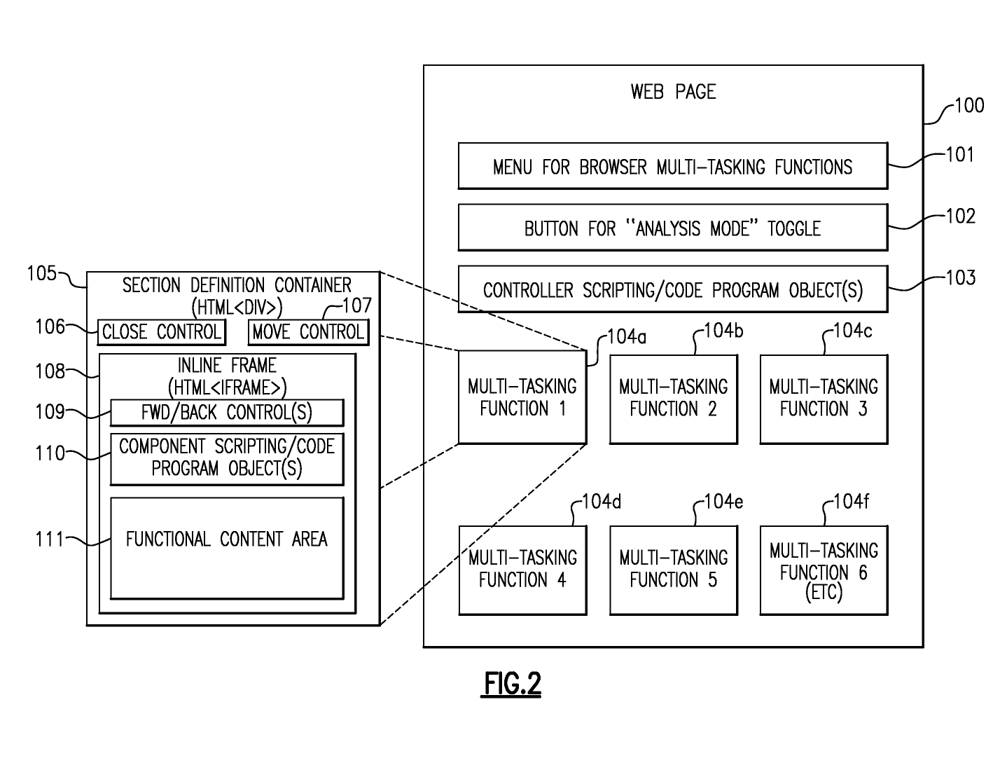

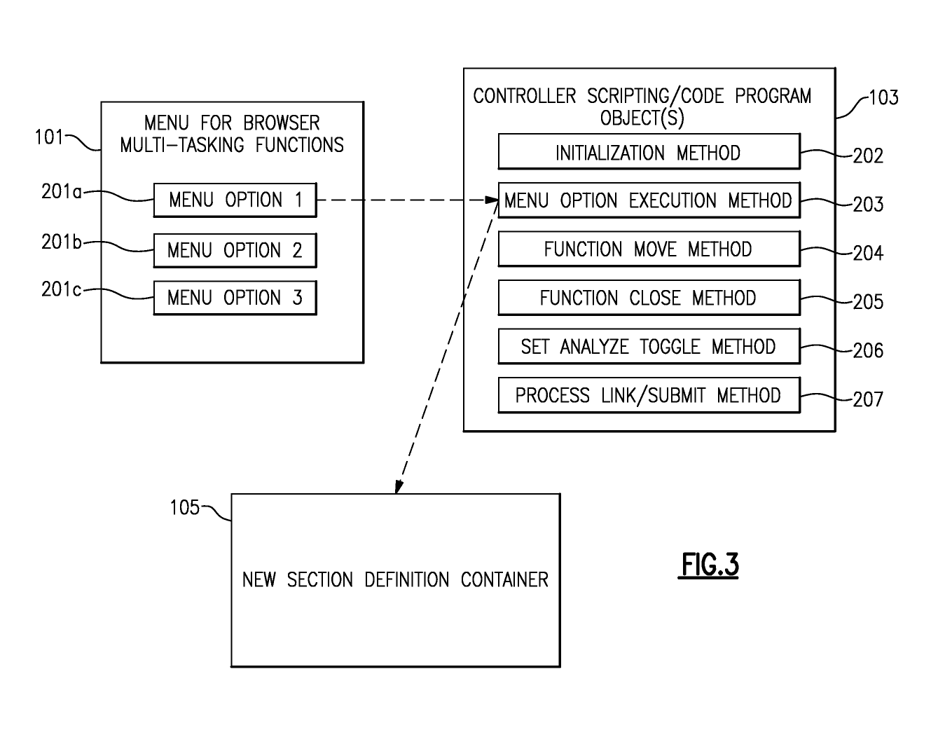

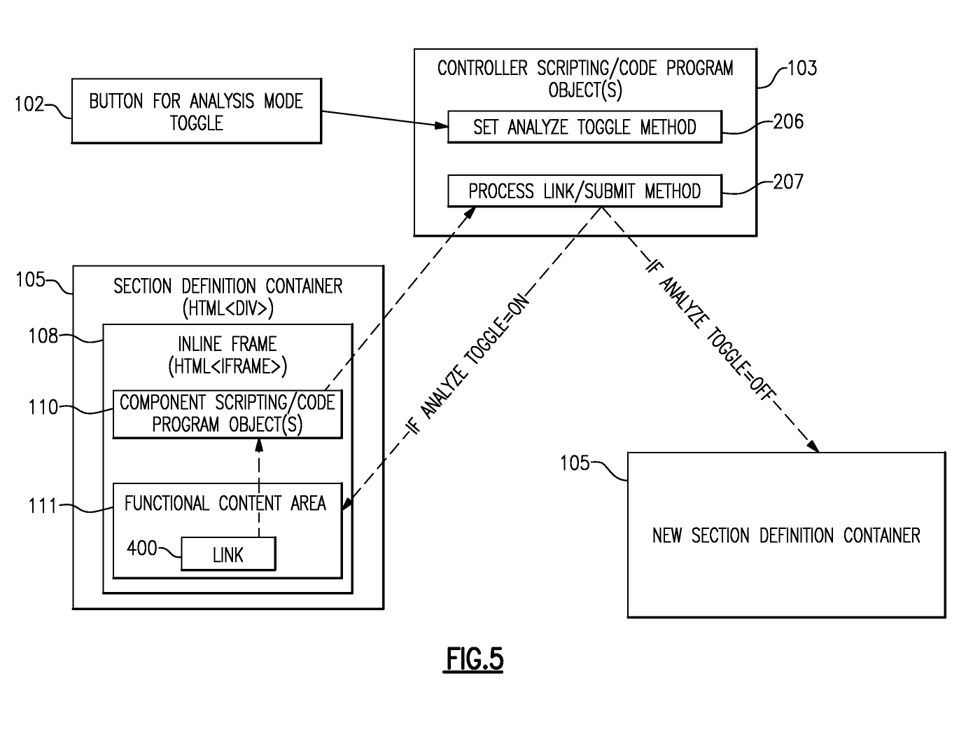

Referring to FIG. 2, a web page 100 is stored and generated by web server 12 (FIG. 1). The web page 100 would be provided to the web browser on the user computing device 24 via the wide area network 22 in a known manner. The web browser on the user computing device 24 could be a general purpose web browser or a dedicated app with browser functionality. Upon initial display, the web page 100 provides a menu 101 containing one or more options 201a-c (see FIG. 3). The web page 100 also provides an analysis mode button toggle 102 to allow the user to specify the behavior of links 400 (See FIG. 5) within each multi-tasking function 104a-f.

A multi-tasking function 104a-f is dynamically created:
in response to the selection of an option 201a-c (see FIG. 3) from menu 101, or;
in response to the execution of a link 400 (see FIG. 5) when analyze mode toggle 102 is set to “on”.

Each multi-tasking function 104a-f is comprised of a section definition container 105. Upon creation, both the section definition container 105 and the inline frame 108 are assigned unique identifiers on the web page 100 by controlling script 103.

Within container 105, there are user interface controls 106 and 107.

The close control 106 allows the user to physically remove the multi-tasking container 104a-f to which it is associated. Upon removing a multi-tasking container 104a-f, the remaining multi-tasking containers 104a-f are reshuffled to compress out any space that was allocated to removed multi-tasking container 104a-f without losing their relative order.

The move control 107 allows the user to drag and drop (either through the use of a touch based device or a mouse pointer) to a new location on the web page 100.

Within each section definition container 105, there also exists an HTML IFRAME element 108. Common components for the forward and backward controls 109 and the supporting program execution object(s) 110 are provided by the web page identified by the “src” attribute of inline frame 108.

The user can choose to open an unlimited number of multi-tasking functions 104a-f.

Creating New Multi-Tasking Functions from the Menu

FIG. 3 provides illustration of how a new multi-tasking function 104a-f is created. Again, each multi-tasking function 104a-f is provided in an exploded component model as screen definition container 105.

Upon selection of a menu option 201a-c from menu 101, the menu option execution method 203 is executed in the controller script function 103 on web page 100.

Menu option execution method 203 performs the following:
Creates a unique identifier for section definition container 105 and inline frame 108;
Constructs the close control 106 and move control 107 objects;
Constructs the required IFRAME SRC string for inline frame 108, passing along the unique identifier of inline frame 108 as a parameter;
Adds section definition container 105 to the end of the HTML DOM tree behind the last multi-tasking function 104a-f.

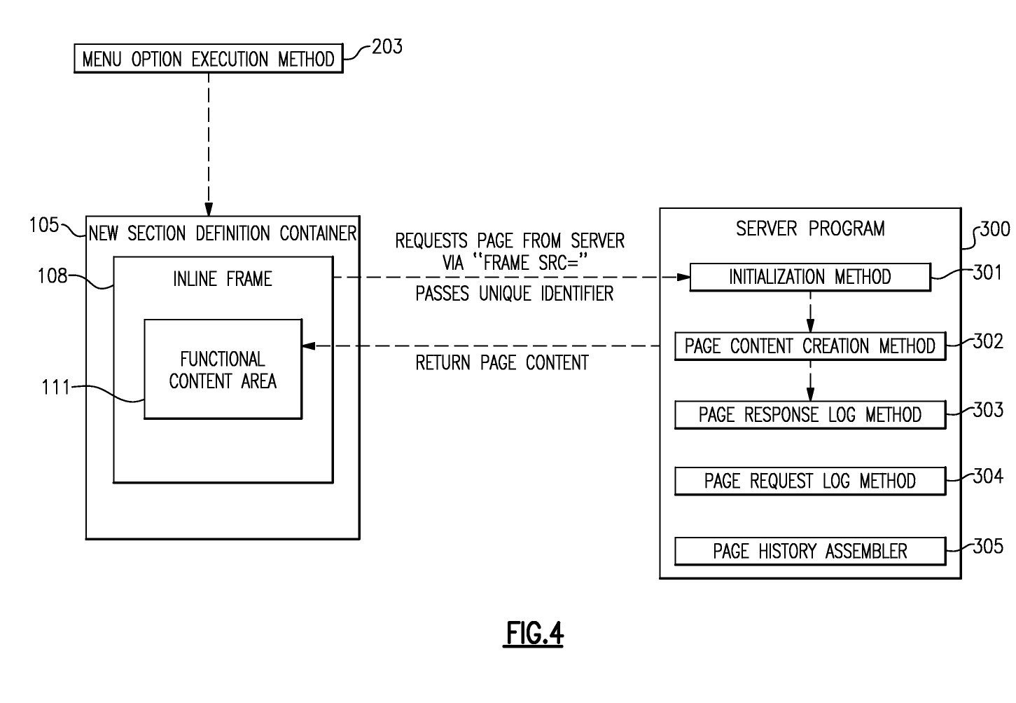

FIG. 4 illustrates the processing that occurs on server program 300 in order to load the contents specified by the IFRAME SRC attribute of inline frame 108.

The server program 300 may be a Microsoft active server page (ASP), a Java Server Page (JSP), or any other server language that is capable of processing a request from the browser and tracking individual user sessions. If desired, server program 300 could also be a client scripting function. Server program 300 may also be split into multiple programs to support the various methods (202-207).

Upon receiving the request for the document from inline frame 108, initialization method 301 is executed by server program 300. Initialization method 301 performs the following:

For the HTTP web page session and unique identifier of inline frame 108 of web page 100, server program 300 initialization method 301 creates in-memory structures to hold HTTP_REQUEST objects and HTTP_RESPONSE objects. Both the HTTP_REQUEST and HTTP_RESPONSE objects are common objects provided to all server-based programs and scripts leveraging HTTP communications. An example of an in-memory structure may be a java HashMap object. Optionally, these structures may be database table objects stored in a database, or other disk-based storage structures, rather than an in-memory set of structures. These structures persist for the duration of the session associated with web page 100.

Subsequently, server program 300 executes page content creation method 302 to satisfy the request from inline frame 108. This data is used to populate functional content area 111. It is understood that forward/backward controls 109 and component script 100 objects are also returned to inline frame 108. The request from inline frame 108 could be for content from the web server 12, content server 16, web server 14 or web servers 18, 20.

During the process of satisfying this request, any links (<A>, for example) or submission targets (<FORM ACTION=“ . . . ”, for example) are enhanced to include the unique identifier of inline frame 108. These links and/or submission targets are documented as link 400 (see FIG. 5).

Next, page response log method 303 is executed to store the information returned to populate inline frame 108 in the HTTP_RESPONSE object structure created in initialization method 301.

Processing Actions in the Multi-Tasking Function

FIG. 5 represents the process of following links within section definition container 105 and the analysis toggle button 102 settings.

Analysis mode toggle button 102 is used to turn the analyze setting from “off” to “on” and back. It is either “off” or “on” and can have no other value or setting.

Upon selecting analysis mode toggle 102, set analyze toggle method 206 is executed from controller scripting object 103 on web page 100. Analyze toggle method sets a variable, accessible to all functions within scripting object 103 to a value indicating the “on” or “off” setting indicated by the user.

Upon selecting link 400 in function content area 111 of section container 105, component scripting object 110 is executed. Component scripting object 110 executes process link/submit method 207 in controller scripting object 103.

Process link/submit method 207 receives the request for the page as specified by link 400. If the toggle mode variable in controller scripting object 103 indicates that the analyze toggle button 102 is set to “on”, then a new section definition container 105 is created in the same manner that a new multi-tasking function is created (as previously documented). Subsequently, processing is returned to component scripting object 110 and execution stops.

If the toggle mode variable in controller scripting object 103 indicates that the analyze toggle button 102 is set to “off”, then processing returns to component scripting object 110 and the execution continues within screen definition container 105. The actual fulfillment of the action requested by link 400 is provided by page request log method 304, page content creation method 302, and page response log method 303, all executed in succession within server program 300.

It should be noted that the component object 110 may be omitted if link 400 has been constructed in such a manner as facilitate direct communications between link 400 and controller scripting object 103 on web page 100. An example of this may be the use of a javaScript function that executes as part of the link 400 which directly references controller scripting object 103. Technically, this may be represented as “<a ref=”javaScript:parent.functionInControllerScript103FunctionXYZ( );”/>”.

Closing the Multi-Tasking Function

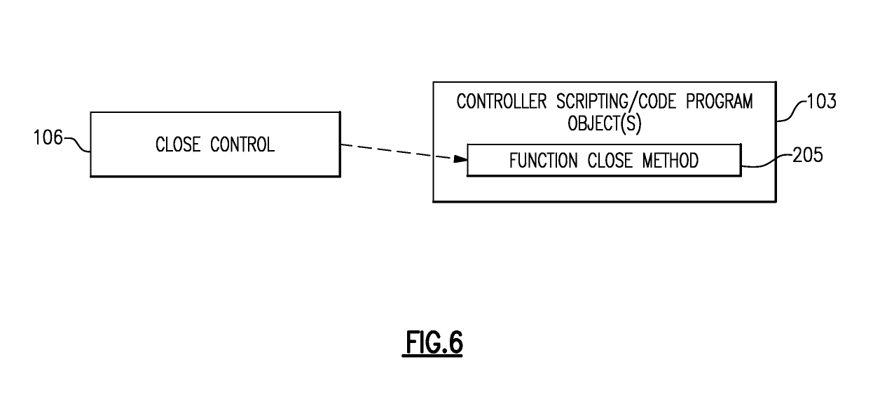

FIG. 6 illustrates the actions of closing section definition container 105. When close control 106 is selected, function close method 205 in controller scripting object 103 is executed. When section definition container 105 was created, it was assigned a unique identifier by either menu option execution method 203 or process link/submit method 207 in controller scripting object 103. This identifier is passed to function close method 205, which performs the following:

Locates section definition container 105 by the unique identifier passed from close control 106;

Dynamically removes section container 105 from the HTML DOM tree.

This results in the dynamic compression of space on web page 100 between any definition container 105 objects before the removed definition container 105, and all section definition container 105 objects that appeared behind the removed object on web page 100.

Moving the Multi-Tasking Function

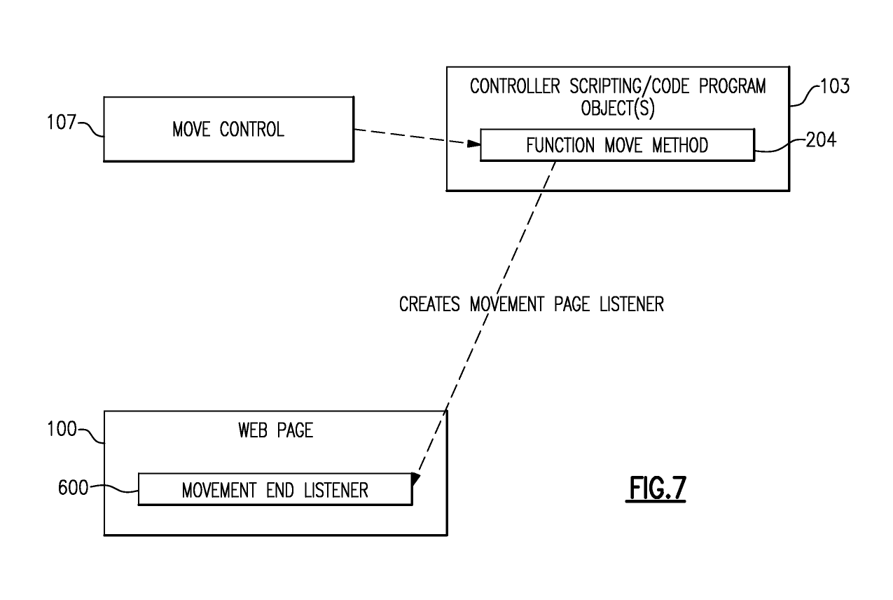

FIG. 7 represents the process of moving section definition container 105 from one location to another location on web page 100. Upon selecting move control 107, function move method 204 in controller scripting object 103 is executed. Function move method 204 starts up movement end listener 600 on web page 100. Movement end event listener 600 executes in the background of web page 100, much like an EventListener javaScript object executed.

Move control 107 is dragged to the new location on web page 100. Upon release, the event listener 600 does the following:
calculates the new position on web page 100 in relation to all other multi-tasking functions 104a-f;
finds section definition container 105 on the HTML DOM;
dynamically removes section definition container 105;
dynamically creates a new section definition container 105 using the same unique id of the removed section definition container 105. This object is added to the HTML DOM tree in front of the unique identifier of existing section definition container 105 (as identified by the release point of event listener 600).
Instructs inline frame 108 to execute page history assembler 305 in server program 300 to populate inline frame 108 with the data last logged by page response log method 303. Page history assembler 305 is described in more detail below.

This serves to appear to the user as if section definition container 105 was moved from one location to another on web page 100 when, in fact, it was effectively deleted and recreated in a new location.

Navigating Forward and Backward Through History of the Multi-Tasking Function

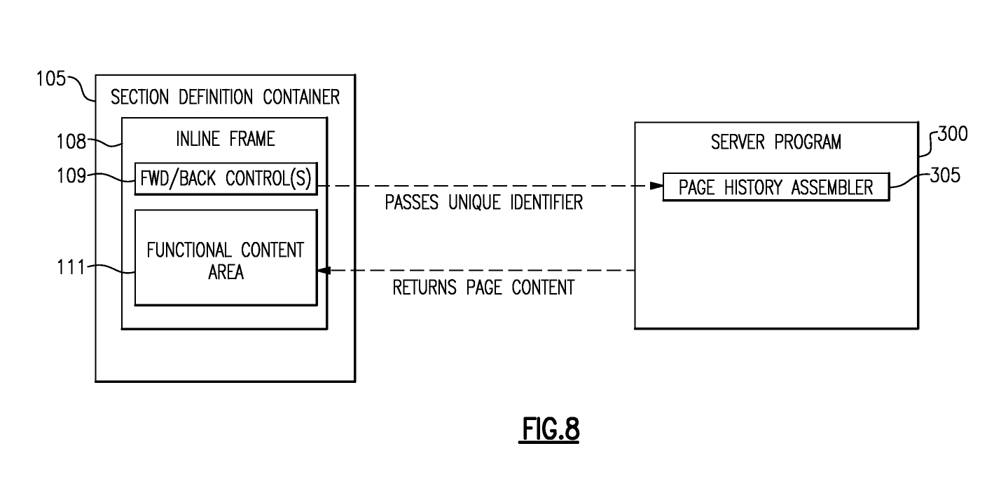

FIG. 8 illustrates the process of navigating forward or backwards through the history of section definition container 105. It is important to note that forward/backward control 109 may be either a single control, allowing the user to specify direction, or two controls, one for forward and one for backward. In either case, it is understood that upon selecting forward/backward control 109, the user has appropriately indicated the direction desired (forward or backward).

Upon selection of forward/backward control 109, page history method 305 is executed in server program 300. Both the direction selected (forward or backward) and the unique identifier of inline frame 108 is passed to page history assembler 305 within server program 300.

Page history assembler 305 accesses the HTTP_REQUEST and HTTP_RESPONSE memory structures created by initialization method 301 of server program 300. Page history assembler 305 performs the following:
Identifies the current HTTP_REQUEST and HTTP_RESPONSE memory structure index;
Based on the direction indicated by forward/backward control 109, selects the next or previous HTTP_REQUEST object;
Based on the direction indicated by forward/backward control 109, selects the next or previous HTTP_RESPONSE object;
Determines if the HTTP_REQUEST and HTTP_RESPONSE objects are to be merged, or simply returns the HTTP_RESPONSE object;
Decrements or increments the index variable(s) used to identify the current location within the HTTP_REQUEST and HTTP_RESPONSE memory structures, based on the direction indicated by forward/backward control 109.

The aforementioned indexes are also manipulated by page response log method 303 and page request log method 304 of server program 300.

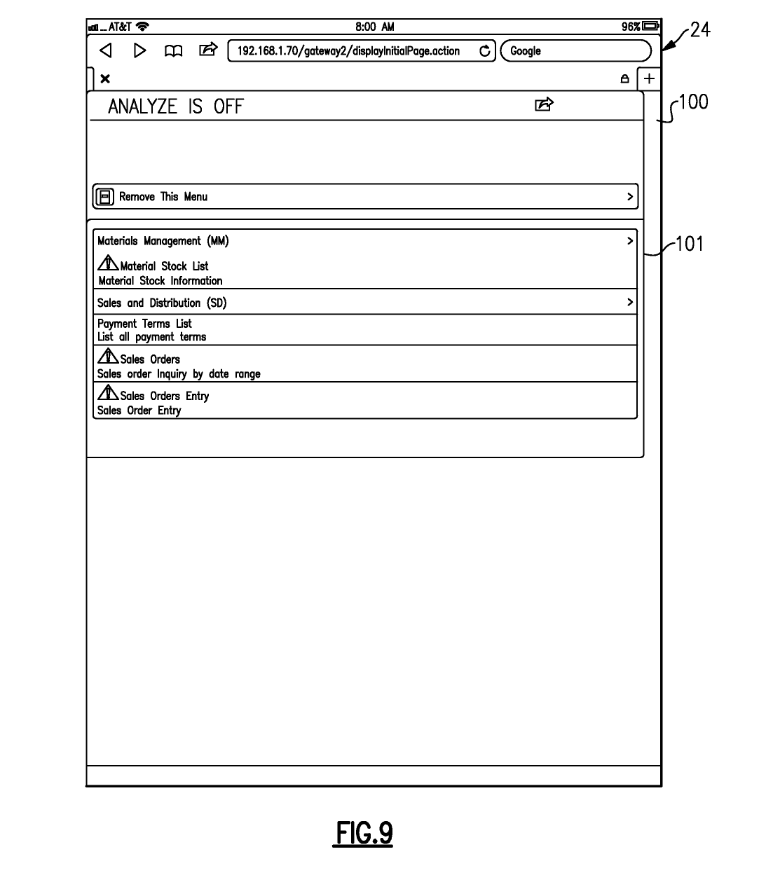

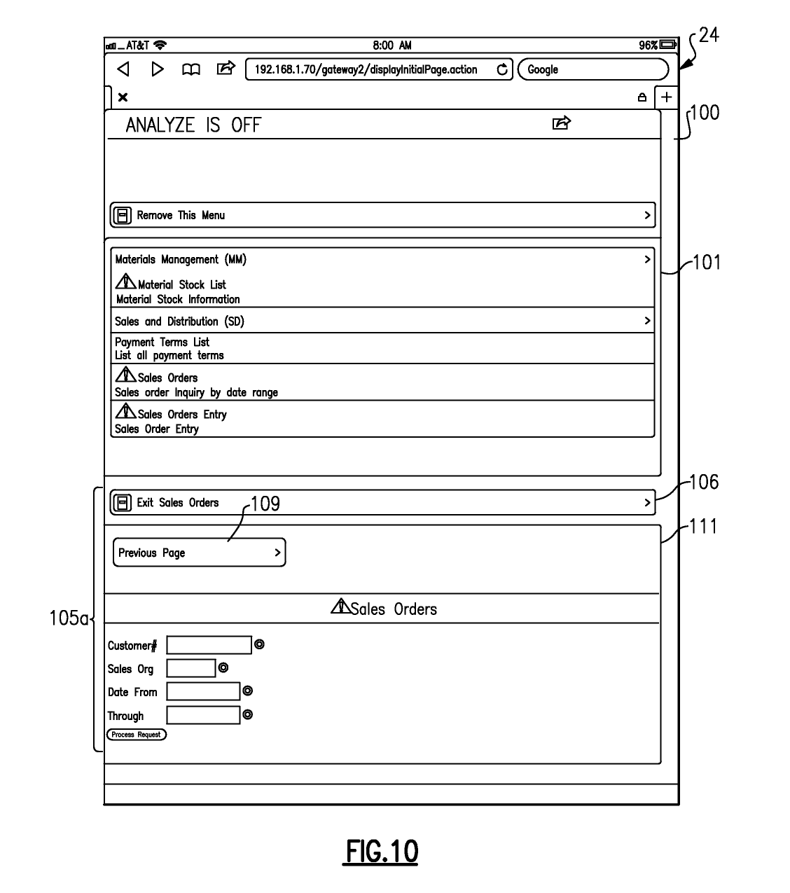

FIGS. 9-13 illustrate an example of the web page 100 as displayed on an example user computing device 24 (in this example, an iPad). As shown in FIG. 9, the web page 100 initial displays the menu 101. As shown in FIG. 10, upon selection of “sales and orders” from the menu 101, the web page 100 adds a new section definition container 105a as defined by the controller scripting object 103. As explained above, the section definition container 105a includes a close control 106 button, a backward control 109 button (and a forward control button, when appropriate) and function content area 111 containing data from the web server 14, the content server 16 (via web server 12) or web servers 18, 20 via wide area network 20, as defined in the controller scripting object 103. The web page in the section definition container 105a can be operated by the user without affecting the web page 100, including closing the section definition container 105a without closing web page 100 and using the history buttons (backward control 109 button) without affecting (e.g. without refreshing or sending backward) web page 100.

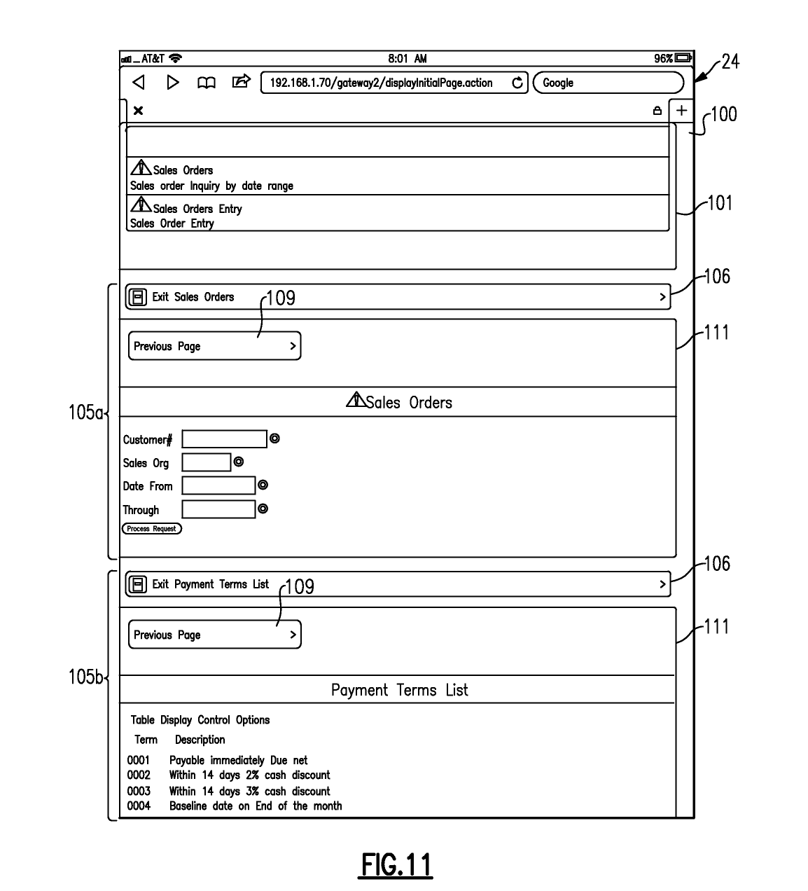

Referring to FIG. 11, upon subsequent selection of “Payment Terms” from the menu 101, the web page 100 adds a new section definition container 105b as defined by the controller scripting object 103. The location of the section definition container 105b relative to menu 101 and section definition container 105a is defined by the controller scripting object 103. Again, the section definition container 105b includes a close control 106 button, a backward control 109 button (and a forward control button, when appropriate) and function content area 111 containing data from the web server 14, the content server 16 (via web server 12) or web servers 18, 20 via wide area network 20, as defined in the controller scripting object 103.

The web pages in the section definition containers 105a, 105b can be operated by the user without affecting the web page 100, the menu 101 or one another, including closing the section definition container 105a or 105b without closing web page 100, the menu 101 or one another. Using the history buttons (backward control 109 button) also does not affect (e.g. without refreshing or sending backward) web page 100 or one another, other than the section definition containers 105a, b being relocated, as defined in the controller scripting object 103

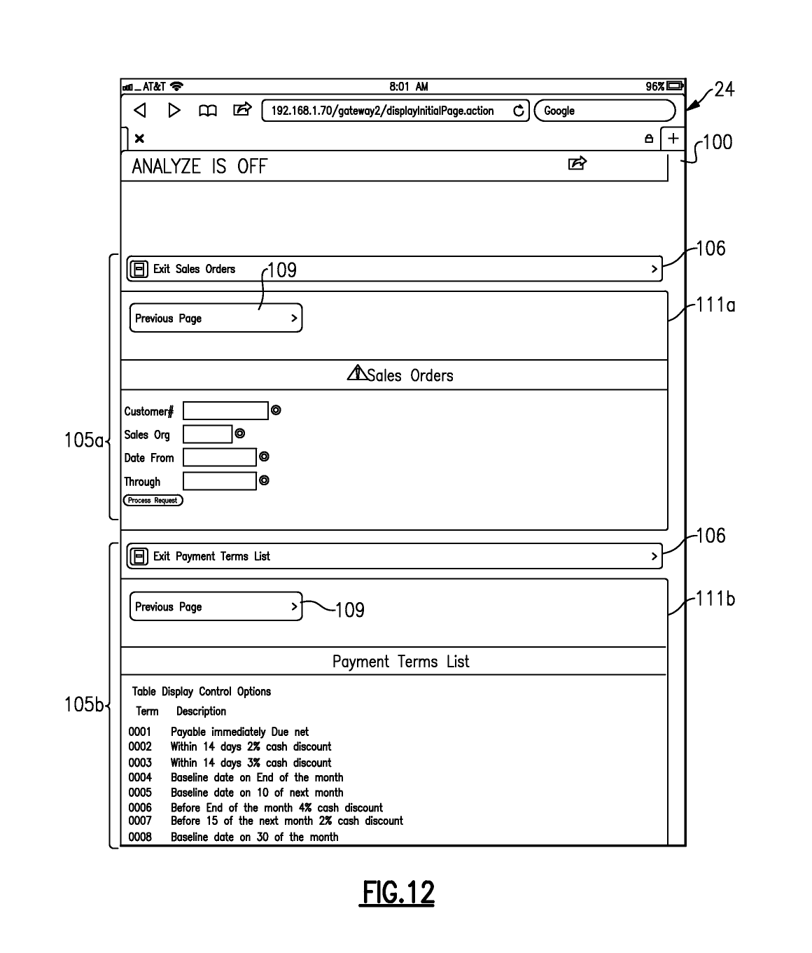

Referring to FIG. 12, the user can close the menu 101 via the close control button (“Remove this Menu”) (FIG. 10) and the section definition containers 105a, 105b are unaffected. The “payment terms” section definition container 105a can be closed (via close control 106) and the sales orders section definition container 105b will be unaffected, other than being relocated, as defined in the controller scripting object 103.

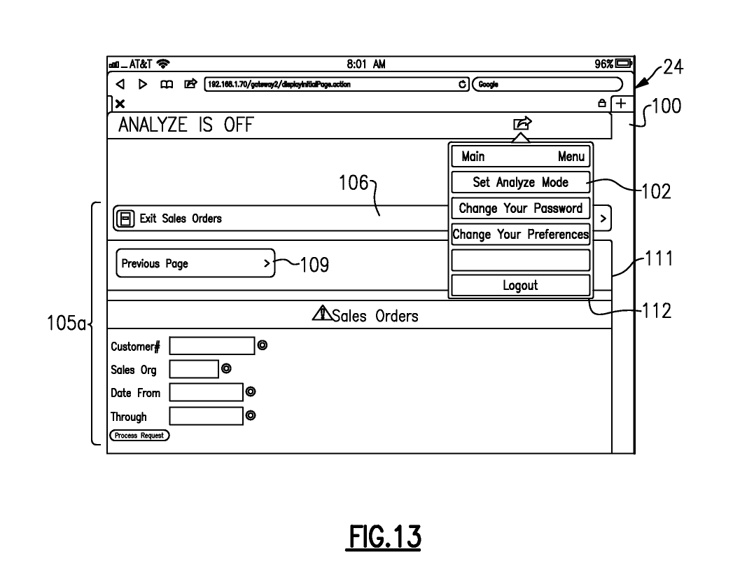

Via a pull-down menu 112 as shown in FIG. 13, the user can restore the main menu 101 (FIG. 9). Via the pull-down menu 112, the user can also choose analyze mode 102.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method of displaying a web page including the steps of:
a) on a computer, generating a web page having a plurality of containers including a first container;
b) receiving a navigation command with respect to the first container;
c) executing the navigation command in response to step b) independently of the second container.

2. The method of claim 1 wherein said step c) is performed without affecting the second container.

3. The method of claim 2 wherein said step c) is performed without refreshing or navigating the second container.

4. The method of claim 3 further including the step of closing the first container without affecting the second container.

5. The method of claim 4 further including the step of providing a menu on the web page independent of the plurality of containers.

6. The method of claim 5 wherein said step c) is performed independently of the menu and without affecting the menu, and wherein the step of closing the first container is performed without affecting the menu.

7. The method of claim 1 wherein the navigation command is a back navigation command.

8. The method of claim 1 further including the steps of:
d) identifying a current HTTP_REQUEST and HTTP_RESPONSE memory structure index;
e) based on a direction indicated by the navigation command, selecting the next or previous HTTP_REQUEST object;
f) based on the direction indicated by the navigation command, selecting the next or previous HTTP_RESPONSE object; and
g) determining if the HTTP_REQUEST and HTTP_RESPONSE objects are to be merged, or if the HTTP_RESPONSE object is to be simply returned.

9. The method of claim 8 further including the step of decrementing or incrementing an index variable used to identify a current location within the HTTP_REQUEST and HTTP_RESPONSE memory structures, based on the direction indicated by the navigation command.

10. The method of claim 8 wherein said steps d) to g) are each performed by executing corresponding instructions in the web page.

11. A method of displaying a web page including the steps of:
a) on a computer, generating a web page having a menu;
b) receiving a first menu selection from a user;
c) generating a first container in response to said step b);
d) displaying the first container on the web page;
e) generating a second container; and
f) displaying the second container on the web page adjacent the first container and independently of the menu and the first container.

12. The method of claim 11 wherein said step c) and said step e) are performed based upon a controller scripting object on the web page.

13. The method of claim 12 wherein the first container and the second container are arranged on the web page in accordance with the controller scripting object on the web page.

14. The method of claim 11 further including the steps of providing an analyze mode option on the web page, receiving an analyze mode request, and executing said step e) based upon the received analyze mode request.

15. The method of claim 14 further including the steps of displaying a link in the first container, receiving an activation of the link, and executing said step e) based upon the received analyze mode request and based upon the step of receiving the activation of the link.

16. A computing device executing a web page, the server storing software, which when executed by the server performs the steps of:
a) generating a web page having a plurality of containers including a first container and a second container;
b) receiving a navigation command with respect to the first container; and
c) executing the navigation command in response to step b) independently of the second container.

17. The computing device of claim 16 wherein said step c) is performed without affecting the second container on the web page.

18. The computing device of claim 17 wherein said step c) is performed without refreshing or navigating the second container.

19. The computing device of claim 18 further including the step of closing the first container without affecting the second container.

20. The computing device of claim 19 further including the step of providing a menu on the web page independent of the plurality of containers.

21. The computing device of claim 20 wherein said step c) is performed independently of the menu and without affecting the menu, and wherein the step of closing the first container is performed without affecting the menu.
